(19) United States
(12) Patent Application Publication
(10) Pub. No.: US 2006/0282683 A1
(43) Pub. Date: Dec. 14, 2006

(54) Flash array read, erase, and program security

(76) Inventors: Subramanyam Chandramouli, Folsom, CA (US); Bharat Pathak, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/152,598

(22) Filed: Jun. 13, 2005

(51) Int. Cl. G06F 12/14

(52) U.S. Cl. 713/189

(57) ABSTRACT

A method and device for providing a secret region in a flash erase block to store a key. A block of memory may only be read, programmed, or erased if a key is provided which matches the key stored in the secret region of the block.

### BACKGROUND

The present invention relates to nonvolatile memory devices and more specifically to a mechanism to prevent unauthorized access to a nonvolatile memory device at the hardware level.

Flash memory and other non-volatile memory devices may be used to store secure, personal information, such as credit card data or other secret data. When secret data is stored on a flash memory device, it must remain secure. Today, much of the security provided for flash memory is performed in software or through a block lock feature. However, these methods may not be sufficient to prevent unauthorized malicious software from reading, programming, or erasing secret data stored in flash memory.

### BRIEF DESCRIPTION OF THE DRAWINGS

A better understanding of the present invention can be obtained from the following detailed description in conjunction with the following drawings, in which:

FIG. 1 is an illustration of a non-volatile memory device according to one embodiment.

FIG. 2 is an illustration of a flow diagram illustrating a program key command according to one embodiment.

FIG. 3 is an illustration of a flow diagram illustrating a read command according to one embodiment.

FIG. 4 is an illustration of a flow diagram illustrating a program command according to one embodiment.

FIG. 5 is an illustration of a flow diagram illustrating an erase command according to one embodiment.

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed.

Embodiments of the present invention concern secure non-volatile memory. Although the following discussion centers on flash memory, it will be understood by those skilled in the art that the present invention as hereinafter claimed may be practiced in support of any type of non-volatile memory.

A better understanding of the present invention can be obtained from the following detailed description in conjunction with the following drawings, in which:

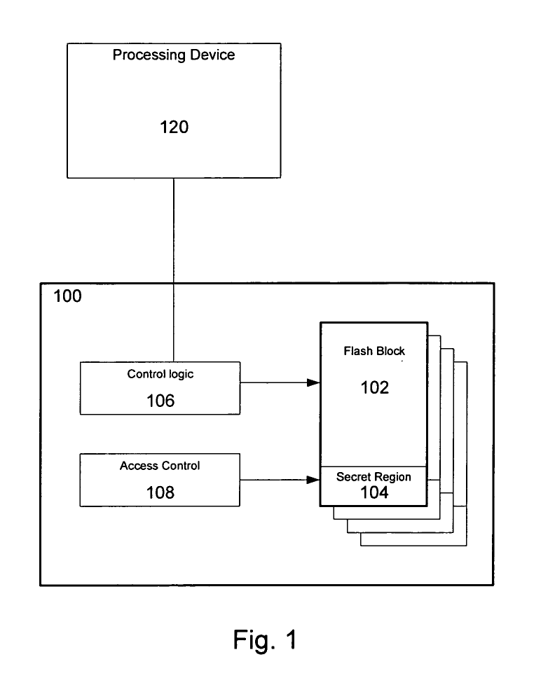

FIG. 1 is a conceptual illustration of a flash memory device 100 according to one embodiment. The flash memory is organized into a plurality erase blocks 102. Each block may be erased independently of other blocks. Erase, program, and read of the erase blocks is controlled by control logic 106.

One or more erase blocks 102 also include a secret region 104. The content of the secret region is visible only internally and may be modified or updated. Each block having a secret region may be individually secured at the hardware level. In one embodiment, all erase blocks include secret region 104. In one embodiment, the secret region is accessible only by logic or firmware within the flash memory, such as access control 108. Access control 108 may be implemented as a microcontroller within the flash device, or may be implemented as firmware.

The secret region 104 may be implemented as one or more additional wordlines within each erase block. The additional wordline(s) are not directly addressable by the user.

The secret region 104 is used to store a user configurable key. The key may be a 16-, 32-, 64- or X-bit number. When a key is stored in the secret region within a block, the key must be provided before the data in the block can be read, programmed, or erased.

The flash memory device 100 may be in a system which includes an external processing device 120. The processing device may be a microprocessor, a microcontroller, or another type of processing device. The processing device has access only to the control logic 106, but may not directly access the secret region 104.

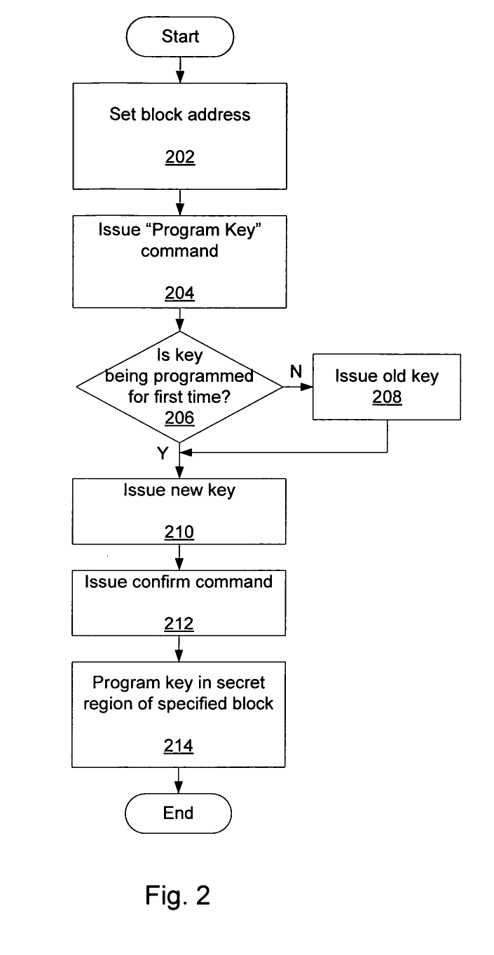

FIG. 2 is a flow diagram which illustrates a method by which the user configurable key may be programmed into the secret region or updated. First, as illustrated in block 202, a block address is set. The block address is set to indicate a block in which hardware level security is desired.

Next, as illustrated in block 204, a command is issued to indicate that a key is to be programmed into the secret region within the block indicated by the block address. If the key is being programmed for the first time (block 206), a new key may be immediately issued (block 210). If the key has been previously programmed, the previous key must be issued (block 208) before a new key may be issued (block 210). This prevents the key from being overwritten by an unauthorized user.

The new key that is issued may be input directly by a user, or may be generated by a random number generator (RNG). Other algorithms or methods may be used to generate the new key as well. After the new key has been issued, a confirm command may be issued (block 212). The confirm command indicates that the issued new key is to be programmed in the secret region of the specified block.

Finally, as shown in block 214, the issued new key is programmed into the secret region of the addressed block. The programming of the key is an internal operation which occurs in the flash device after the confirm command is received.

After a key has been programmed in the secret region of a block, that block is secure, and may not be accessed unless the key is provided.

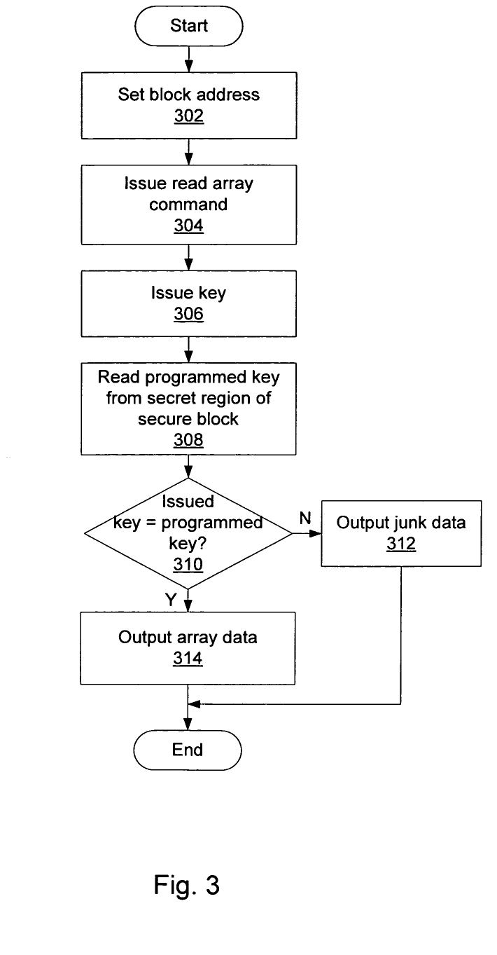

FIG. 3 is a flow diagram which illustrates a method by which the data in a secure flash block may be read. First, as illustrated in block 302, a block address is set. The block address is set to indicate a secure block having a secret region and containing data to be read.

Next, as illustrated in block 304, a read array command is issued. After the read array command is issued, the key is issued (block 306). The programmed key is then read from the secret region of the secure block (block 308). The read of the secret region is done internally within the device itself, and cannot be performed based on a command from an external user. No one external to the device will be able to perform a read of the secret region.

The issued key is compared to the programmed key, as illustrated in block 310. In one embodiment, the issued key may be compared to the programmed key by embedded software in the flash device. In another embodiment, this comparison may be done by a hardware accelerator in the flash device.

If the issued key matches the programmed key, the read array command is allowed, and array data is output to the user (block 314). If the issued key does not match the programmed key, junk data is output (block 312).

In one embodiment, a counter may be used to determine how many times the issued key is compared to the programmed key before a match is made. If too many attempts are made before a match is made, and thus the counter exceeds a predetermined threshold value, the block may be retired. In such a manner, blocks could be rendered permanently inaccessible if an unauthorized user attempted to access a block.

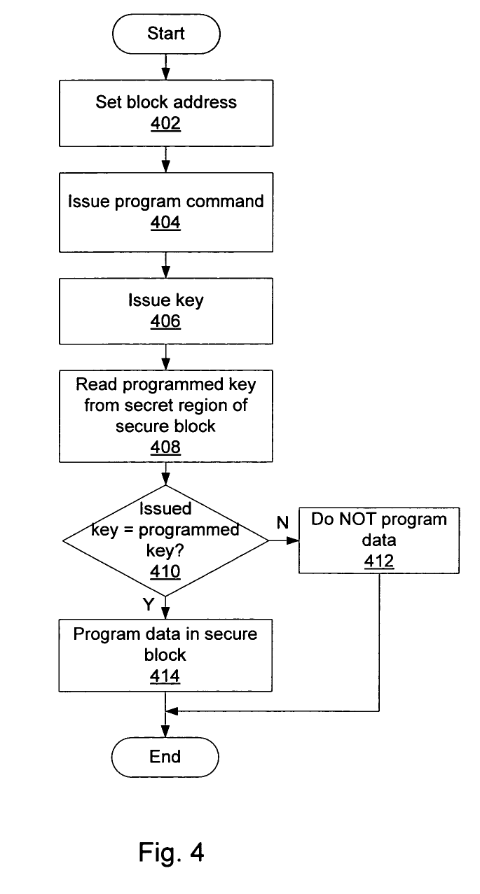

FIG. 4 is a flow diagram which illustrates a method by which the data in a secure flash block may be programmed. First, as illustrated in block 402, a block address is set. The block address is set to indicate a secure block having a secret region, where data is to be programmed.

Next, as illustrated in block 404, a program command is issued. After the program command is issued, the key is issued (block 406). The programmed key is then read from the secret region of the secure block (block 408).

As described above with respect to FIG. 3, the issued key is compared to the programmed key, as illustrated in block 410. If the issued key matches the programmed key, the program command is allowed, and data is programmed in the secure block (block 414). If the issued key does not match the programmed key, no data is programmed (block 412).

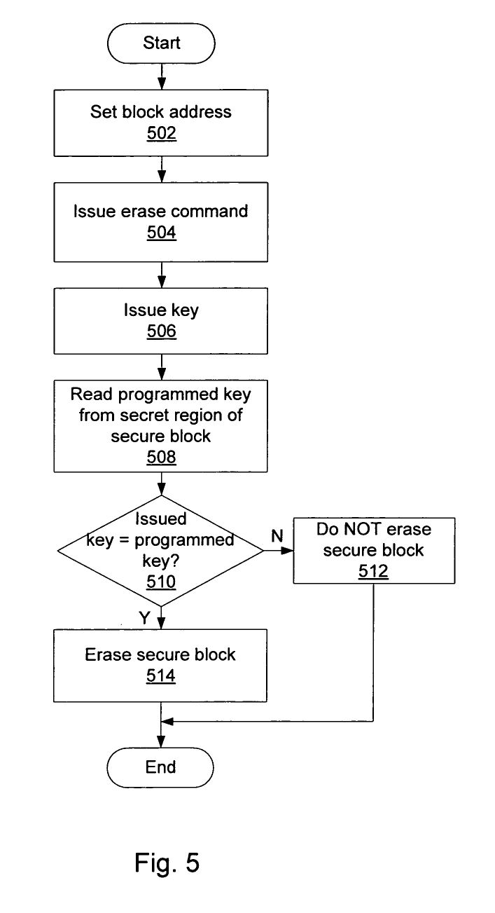

FIG. 5 is a flow diagram which illustrates a method by which the data in a secure flash block may be erased. First, as illustrated in block 502, a block address is set. The block address is set to indicate a secure block having a secret region and containing data to be erased.

Next, as illustrated in block 504, an erase command is issued. After the erase command is issued, the key is issued (block 506). The programmed key is then read from the secret region of the secure block (block 508).

As described above with respect to FIG. 3, the issued key is compared to the programmed key, as illustrated in block 510. If the issued key matches the programmed key, the erase command is allowed, and data in the secure block is erased (block 514). If the issued key does not match the programmed key, the block is not erased (block 512).

Embodiments of the present invention may be used in any device requiring secure non-volatile memory storage. Examples of such devices include, but are not limited to handheld computing devices, mobile computing devices, and cellular telephones.

Thus, a method, apparatus, and system for flash array read, erase, and program security are disclosed. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

We claim:

1. A method comprising:
providing a block address for an addressed block;
issuing a command to perform an operation on the addressed block;
issuing a key; and
performing the command operation only if the issued key matches a stored key.

2. The method of claim 1, wherein the command is a read command.

3. The method of claim 2, further comprising outputting junk data if the issued key does not match the stored key.

4. The method of claim 1, further comprising retiring the addressed block after a predetermined number of match attempts have been unsuccessful in matching the issued key to the stored key.

5. The method of claim 1, wherein the command is a write command.

6. The method of claim 1, wherein the command is an erase command.

7. The method of claim 1, wherein the stored key has been generated using a random number generator.

8. The method of claim 1, wherein the stored key has been programmed by a user.

9. The method of claim 8, wherein the stored key is stored in the addressed block of memory.

10. The method of claim 9, wherein the stored key is stored using an extra wordline.

11. A flash memory device comprising:
a microcontroller; and
a plurality of blocks, at least one of the plurality of blocks containing a region dedicated to key storage, wherein the region is only accessible by the microcontroller.

12. The flash memory device of claim 11, wherein the region dedicated to key storage is a wordline within each block.

13. The method of claim 12, wherein each of the plurality of blocks contains a region dedicated to key storage.

14. A system comprising:
a processing device;
a memory device coupled to the processing device, wherein the memory device includes control logic accessible by the processing device, the control logic providing access to a plurality of blocks, each block containing a secret region accessible only by access control means internal to the memory device.

15. The system of claim 14, wherein the memory device is a flash memory device.

16. The system of claim 14, wherein the secret region is a wordline within each block.

17. The system of claim 16, wherein the secret region is dedicated to key storage.
